(19) United States
(12) Patent Application Publication
(10) Pub. No.: US 2007/0088518 A1
(43) Pub. Date: Apr. 19, 2007

(54) Automated method for generating program modules, to be used for controlling field devices, from a machine-readable parameterized specification of the field devices

(76) Inventor: Michael BRAUN, Hatzenbuehl (DE)

Correspondence Address: Siemens Corporation;Intellectual Property Department, 170 Wood Avenue South, Iselin, NJ, 08830, US

(21) Appl. No.: 10/500,414

(22) PCT Filed: Dec. 12, 2002
(86) PCT No.: PCT/EP02/14166

§ 371 Date: Jul. 13, 2006

Related U.S. Application Data
(60) Provisional application No. 60/343,701, filed on Dec. 27, 2001.

(51) Int. Cl. G06F 19/00

(52) U.S. Cl. 702/108

(57) ABSTRACT

Disclosed is an automated method for generating program modules used for controlling field devices by means of a machine-readable parametered description of the field devices. The inventive method is used with a control unit controlling the field devices. Each of said field devices comprises control devices with at least one microprocessor, at least once electronic storing means, and data input and output means for communicating with the control unit. The novel method consists of the following steps: the parameters of the field device contained in the description are detected; the control-relevant characteristics of the respective parameters, which are defined in the description, i.e. particularly the type of data, size, allowed variables or allowed range of variables, are detected; program modules are generated for the control device of the field device, which can be executed by the microprocessor of the field device and are least in part based on the detected parameters and/or the detected control-relevant characteristics of the parameters.

### CROSS REFERENCE TO RELATED APPLICATIONS

This application is the US National Stage of International Application No. PCT/EP02/14166, filed Dec. 12, 2002 and claims the benefit thereof. The International Application claims the benefits of U.S. application No. 60/343,701 filed Dec. 27, 2001, both of the applications are incorporated by reference herein in their entirety.

### FIELD OF INVENTION

The invention relates to an automated method for generating program modules, to be used for controlling field devices, from a machine-readable parameterized specification of the field devices, which is used on a control unit to control the field devices, where each of the field devices incorporates control equipment with at least one microprocessor, with at least one electronic storage means and with data input and output means for communications with the control unit.

### BACKGROUND OF INVENTION

Devices for measuring and positioning, recording and regulating form the main part of any system for the automation of industrial processes. These devices are referred to collectively as field devices. In the case of measuring devices, they serve in particular to record and report the variables which are central to production, such as pressure, flow rate, level of fullness and temperature. In the case of positioning regulators they often have the functionality of a valve, which makes it is possible to control the flow quantities, either continuously or discretely.

In practice, a distinction is made between two components in the case of the frequently-encountered field measurement devices. The so-called measurement sensors comprise all the equipment and measuring instruments which are required for the creation of a raw measurement result. In the case of a flow-rate meter these might be the measurement tube itself together with measuring probes, for example electrodes, which in some circumstances may be let into the lining of the tube. Connected to these is generally a so-called transducer which, as the second component, essentially serves to carry out the first processing on the output data made available by the measurement sensor. Certain simple signal processing tasks, such as self-monitoring by the system or the calibration and damping of the measured values, can here be carried out even within the field device itself. Apart from this, facilities are commonly also provided in the transducer for remote control of the field device, so that not only can the processed measurement data be passed on but the operating states of the field device can also changed by an external control unit.

This subdivision of the field devices into two parts, on the one hand an executive device (measurement sensor) and on the other hand a transformation device (transducer) is common not only for measurement field devices, but generally for most types of modern field device. Although it would not be necessary to manufacture and market the two components separately, the existence of a transformation device allows one to recognize a critical characteristic of modern field devices: they have a certain level of data processing capacity, and can therefore also be called intelligent field devices.

The particular needs of complex plant structures are reflected in this characteristic. The more diverse and flexible the control options become, on the one hand, and the higher the demands in terms of precision and reliability on the other hand, the greater become the volumes of data necessary for the control of automated systems. In this situation, the bus system used often stands out as the bottleneck, the capacity of which is ultimately solely responsible for the maximum data processing speed achieved. This has resulted in the trend to decentralize data processing as much as possible and to reduce to a minimum the volumes of data transported.

Not least, this decentralization of the data processing poses special demands on the field devices which are used, and also leads to the development of the transformation devices mentioned, such as transducers. Speaking more generally, it is common nowadays to provide control equipment in intelligent field devices: on the one hand this serves to read out, pre-process or generate the electrical output signals from the measuring, regulation or positioning instruments used in the field device. On the other hand, with the help of the control equipment it is possible to establish a link to an internal or external control unit.

For the remote control of field devices, use has long been made of so-called hand-held terminals, which usually communicate with the field devices via the field bus by means of the so-called Hart protocol. However, with increasing frequency computers connected to the field bus are being used, with communications again based on the Hart protocol or alternatively on the more modern Profibus protocols (Profibus-DP, Profibus-PA). In these cases, the links from the computer to the field bus are established via so-called coupling modules.

In order to cover the application areas of modern intelligent field devices, which in some cases are wide-ranging, the remote control devices cited must typically be able to fulfill the following functions. Above all, the objective is to set and change the parameters required for the operation of the field device. The data received from the field device must be checked for plausibility, and it must be possible to compare it with older data. Finally, it is desirable to be able to simulate the behavior of the field device under particular conditions.

Fulfilling these tasks requires that the control unit is provided with certain items of data which represent the characteristics of the field device. This is often effected by means of a machine-readable parameterized description of the field device. A familiar example of such a description is the so-called Device Description Language (DDL). This consists of a list of the variables and menus, to each of which is assigned certain specific attributes for the field device concerned. These variables then specify parameters which are necessary for controlling the field device or for reading out its measured values. The menus describe an operating structure which is either necessary or at least useful for fulfilling the control tasks. The parameterized description thus specified can be read and interpreted directly by the hand-held terminals or PC-based software. This makes it possible for the general control software, which can be used for a multitude of field devices, to be completed with the data for the specific characteristics of a particular field device. The conversion of the parameterized description into an executable control program then does not require any further steps to be undertaken by hand on the control device side.

On the field device side, no such automated conversion of the parameterized description is known in the prior art.

However, here too it is necessary to create program modules which are stored in the control equipment of the field device and which, when they are executed, undertake the necessary control tasks (firmware). Among these program modules it is typically possible to distinguish two blocks. A general analog input block collects together the solutions to various tasks which arise with almost all the different field devices. Such general tasks consist, for example, in interrogating and passing on a damping variable for the impending measurement, in regulating the monitoring of a limiting value, in resealing the data value output by the measurement sensor, and finally in making available a certain default value, for use as the substitute value in the event of a limiting value being incorrectly exceeded, and thereby ensuring that the controlled process can continue to run in safety. A second program module block, called the transducer, brings together all the procedures which are specific to the particular type of field device.

With the solutions available under the prior art, the software in these two blocks must always be created individually in the works by the manufacturer of each new type of field device. In doing this, it is true that in the context of the analog input block the developer can largely build on existing procedures. However, this does not fundamentally prevent the problems, which occur whenever new software is created, from coming to light even in this case. Here, the problems consist not only in the usual requirements for a fault-free, executable and secure program, and one which is well-documented for the purpose of maintenance.

The particular requirement is namely to structure the program modules, which can be executed on the field devices, consistently with the programs in the control units. Inconsistencies between the firmware and control unit can only, if at all, be detected and eliminated with great effort by extensive tests. Because they do not necessarily lead to error messages or system crashes which can be traced, but may possibly simply corrupt the output signal in such a way as to make it exceptionally difficult for staff to determine the cause. If, say, there is a sign error in the program module which undertakes resealing of the data supplied by the sensor, this incorrect measured value will initially be passed over to the control unit. If the incorrect measured value still lies within a theoretically conceivable range, the fault cannot necessarily be spotted, but the operating staff may possibly feel obliged to undertake certain measures to correct the value, which would be unnecessary if the true measured value were known. If the measured value lies outside the conceivable range, then the causes of the error will often be sought initially within the hardware which is being used.

A further disadvantage of this customized development of the firmware consists in the fact that the developer commonly works from a specification of the field device which has been set down in text as the documentation of the characteristics of the field device. The software developer is required in addition to interpret this specification, which almost always involves additional imprecisions and errors.

The prior art thus only describes methods by which the program modules for controlling the control unit, on the one hand, and for the field devices on the other, are created separately from each other. These solutions are obvious, and only appear consistently because the system prerequisites for the two units are different. This applies not only to the hardware components but also, on the one hand, to the operating systems of the hand held terminals or computers, as applicable, or on the other hand to the microprocessors in the field devices.

### SUMMARY OF INVENTION

starting from this prior art, the invention sets as its object the creation of an automated method for generating program modules, for use in controlling field devices, which avoids the need for the independent creation of firmware, and thus prevents in principle the possibility of inconsistencies arising between the program modules for the control units and those of the field devices.

The invention achieves this object by the claims.

This method starts from the machine-readable parameterized description of the field devices which is used on a control unit for controlling the field devices. Such a parameterized description is already known in the prior art and can, as indicated above, generally be interpreted directly by the control programs. In accordance with the invention, the parameters for the field device, contained in the description, and the characteristics relevant for control purposes which are defined by the description, can be identified from the parameters concerned. These are the data type, the size, the set of permitted values or the permitted value range, as appropriate. In addition, for at least one of the identified parameters program modules, which can be executed by the field device's microprocessor, are generated for the field device's control equipment. First, it is possible to generate definition modules, which define for the parameter concerned certain segments of the storage means, the data type and/or the size. Secondly, access modules can also be generated which, for the parameter concerned, regulate the access by the control equipment to the associated storage segment, and which prompt the control equipment to execute other program modules when the parameter is accessed.

The automatic generation of these two types of program modules satisfies the core task of the developer of the firmware. In the field device's storage means, segments are defined which correspond to the particular operating parameter of the field device. Access by the field device's control equipment to the parameter value concerned is then controlled in the access module.

In that the invention is based on a machine-readable parameterized description of the field devices, it falls back on a functional module which the familiar methods produce in any case for each type of field device, and which is put into service on the remote control units. There, such descriptions of the field devices are used to supply the control programs with data and information about the specification of the field device which is to be controlled. In that the invention subsequently analyzes the parameters contained in such descriptions and their attributes which are relevant for control purposes, and from them generates program modules for the field device's control equipment, it renders any separate manual programming of these modules superfluous. In this connection, the advantages of such an automated method for the generation of this firmware lie not only in the time saving and precision achieved in program development. Rather, its use also enables inconsistencies between the control programs involved to be effectively avoided: the program modules which run on the field device's microprocessor are based on the same parameter specification as also underlies the executive program of the control unit.

In an advantageous form of embodiment of the invention it is possible in addition, for at least one parameter, to generate an input checking module which can be called up from the access module when a parameter is changed, to determine whether the parameter value lies within the set of permitted values or within the permitted range, as appropriate. Furthermore, an advantageous possibility is to generate an error message if the parameter value concerned fails this consistency check. It is true that such input checking modules, which check the input of a control value for its consistency, are already frequently provided in the general control software for control units. Here, if there is an erroneous input, an error message can immediately be displayed to the user, who can be required to make a new input. With additional, automatically generated, input checking modules on the field device side itself one initially achieves only additional security. However, these modules reveal their full effectiveness in the context of “standalone operation” of the field device. As has already been indicated above, many field devices are intended not only for operation under remote control, but are provided in addition with a display and input devices, which permit operational states to be set up directly on the field device itself. For this operating mode, the field device and its firmware must themselves undertake the consistency checking on values which have been input, which requires input checking modules of the type cited to be a component part of the firmware.

In another advantageous form of embodiment, a naming module is generated for at least one parameter, to enable a name for the parameter to be stored in the storage means, and the parameter to be accessed under this name. Only when an internal variable name is linked to an explanatory name does user-friendly operation of the field device become possible. It is true that, with a remote controller, such a link can be effected by the software which is executed on the control unit, as is common in the prior art. But in this connection too, the aim must be to enable convenient and user-friendly “standalone operation”.

An example of the invention is explained in more detail below, by reference to the attached diagrams.

### BRIEF DESCRIPTION OF THE DRAWINGS

FIG. 1 shows a system for monitoring and controlling the flow rate of a fluid through a pipe,

FIG. 2 shows schematically programming steps,

FIG. 3 shows an embodiment of the invention in a diagrammatic form,

FIG. 4 shows a second embodiment of the invention,

FIG. 5 shows part of a description written in the Device Description Language (DDL),

FIG. 6 sketches the order of events in an advantageous application of the invention and

FIGS. 7-9 show flowchart diagrams corresponding to the invention.

### DETAILED DESCRIPTION OF INVENTION

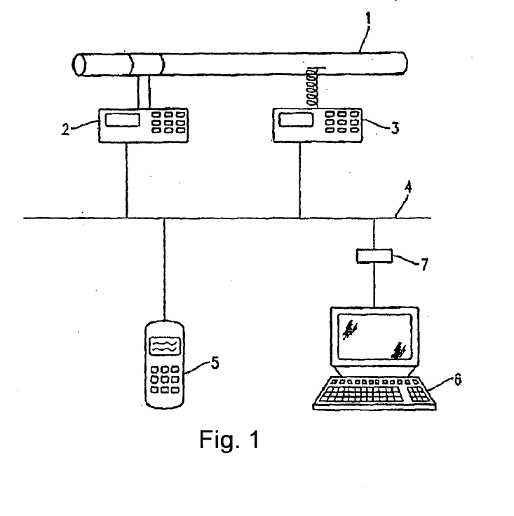

FIG. 1 shows a system for monitoring and controlling the flow rate of a fluid through the pipe 1, which uses two field devices: a flow rate meter 2 together with a continuously adjustable valve 3. These field devices are connected via the field bus 4 with the control units 5, 6, where 5 represents a hand-held terminal and 6 a commonly purchasable personal computer. For communication purposes, the data line between the field bus 4 and the computer 6 is provided with a coupling module 7. There is an option to carry out all the control and monitoring tasks on either of these control units. In particular, the data sent out by the field device can be received and reproduced, so that the operating staff can obtain a reliable impression of the operating states of the flow rate meter 2 and the adjustable valve 3. On the other hand, however, it is also possible for the control units 5, 6 to exercise a direct influence on the field devices 2, 3. For example, the flow rate measurement can be restricted to a particular time interval, which involves a start signal or stop signal being sent to the flow rate meter 2 at the start and the end respectively of this time interval. It is also possible to change the damping applied to the value determined by the flow rate meter 2. This is an important output variable for the preprocessing, which takes place even within the field device 2, of the raw measured value. It specifies the time interval over which the recorded data is determined. Modern flexible field devices often cover different measurement ranges. This ray make it necessary, for example, to carry out resealing of the raw data even within the flow rate meter 2, with the measurement range and the scaling factor being adjustable by means of a command from the control unit 5, 6. But is it also conceivable that, for the purpose of calibrating the field devices, certain calibration signals are sent from the control units 5 and 6 to the field devices.

In order for the bidirectional data traffic described, between the control units 5 and 6 on the one hand and the field devices 2 and 3 on the other hand, to function it is necessary that the program modules in the devices are matched to each other. In particular, the specifications of each of the field devices, that is the special characteristics of the device type concerned, must be known when the program is being generated. These specifications then provide the parameters required for control purposes, together with their characteristics. For example, for one of the control tasks identified above, the control modules must include a parameter which regulates the damping of the raw measured value. This parameter has certain characteristics: for example, the data which it stores may be of the floating point type with “single” precision. Further, damping may only be permitted in a certain range, the upper and lower limits of which must be specified in the description.

Such descriptions are commonly set down in text form by the developer of the field device, and are interpreted and applied by the programmers of the software which is used in the devices. That is to say, the developer of the device specifies how the damping is to be effected, what the precision and data format must be for the damping parameter which is to be input, and what parameter values are basically permissible.

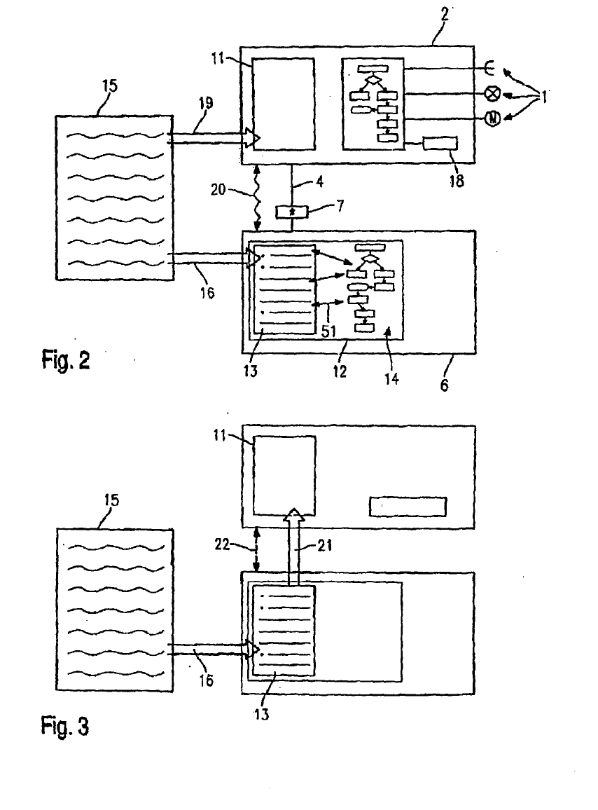

FIG. 2 shows schematically the programming steps which are to be carried out according to the familiar methods. A field device 2 is connected via a field bus 4 with a control computer 6. Bidirectional data and commands can be exchanged between the field device 2 and the computer 6 which is serving as the control unit, via a coupling module 7 on the control computer 6 side. The functionality of the control computer is determined by control software 12. This includes a general part 14, which incorporates the basic control routines, the user interface and the interface programming. This general part 14 of the control software also represents the framework of the control program, it can in principle be used for a multitude of field devices.

However, in order to adapt this framework for any particular type of field device, the control computer 6 must provide stored data which reflects the particular specification of the device type. This is done by incorporating a machine-readable parameterized description 13 of the field devices. This consists mainly of a list of parameters which are required to control the field device. Examples of these are the damping, codes for switching the field device on and off, upper and lower limits (which, when the values exceed or fall below them, generate error messages), codes for calibrating the device, together with factors for resealing the data sensed by the intelligent field device. At this point, this list must be made very selectively, because the control of modern field devices requires approximately 100 such parameters. Nowadays, the parameterized description 13 is usually stored in an agreed syntax, called the DDL (Device Description Language). This is directly machine-readable insofar as the sections concerned for the individual parameters can be directly read in 51 and interpreted by the routines of the general part 14 of the software. The description itemized in the DDL is conventionally produced on the basis of a description 15 set down in text form. In this, the developer of a new type of field device gives a comprehensive description of the specification of the new device. To do so, he must at least implicitly go into the parameters cited which are relevant for control purposes, and their characteristics, but may not feel obliged to itemize the description in machine-readable form. Instead, it will much more often be the case that, for example, not all of the characteristics of a parameter will get a mention, because the developer can rightly assume that a reader will be able to supplement these characteristics logically if he is a person skilled in the art and familiar with corresponding equivalent devices.

The conversion of this description 15, set down in text form, into the machine-readable parameterized description 13 is shown in the sketch as the conversion step 16. In practice, this step is subject to numerous sources of error, which result not only from the incompleteness but also from the unavoidable ambiguity of a description in text form. A certain degree of interpretation is always required of the programmer of the DDL 13, as a result of which inaccuracies or even errors can arise in the DDL script. Because DDL in its present familiar form provides a very simple and intuitively comprehensible syntax, many developers of field devices therefore feel obliged to undertake the description in DDL themselves.

For the purpose of performing the control tasks which fall to the intelligent field device 2, certain program modules 11, referred to collectively as firmware, are brought to execution on the microprocessor of the field device 2. The primary purpose served by this firmware is to control and read out from the field device's actuators and sensors 17. However, data, measured values and commands can also be stored here on storage module 18, which likewise belongs to the field device, and processed on the microprocessor in a manner prescribed by the firmware. It is clear that here again separate software must in principle be produced for each type of field device, generated with regard for the hardware components concerned and their functionality.

It is known how to generate 19 this firmware from the description of the field device 15 set down in text form. This program step is also subject to the same uncertainties as the conversion 16 of the text description 15 into the DDL 13. It is indeed true that the programmer of the firmware can fall back on existing (standard) program modules (so-called analog input blocks) for a large proportion of the software which needs to be produced. Equally, he is obliged to take into account, and incorporate into the program modules in the correct place, matters which are specific to the field device, which are laid down in the text format description 15. This familiar method has the following problem: it is essential that there is absolute consistency between the software blocks in the control computer 12 and in the firmware 11. Any disagreement between these program blocks could lead to unforeseeable errors, some of which are exceptionally difficult to track down because they may only come to light under certain operating conditions of the field device or the control computer. The consequence is that, with the familiar prior-art methods, exceptionally comprehensive test phases must be carried out, before the newly-developed software can be considered as error-free, and thereby the field device reaches market-readiness. These problems are fundamentally due to the fact that two interpretation steps 16 and 19 are required, which are independent of each other.

By contrast, the invention proposes a method by which the firmware 11 which is to be newly created is generated directly from the machine-readable parameterized description 13 which is in any case available. This is represented in diagrammatic form in FIG. 3. In this way, it is possible to forgo the interpretation and software generation step 19. Its place is taken by the automatic program generation 21, which starts from the machine-readable description. In this way, inconsistencies between the different program modules become impossible in principle, because the firmware 11 is of necessity based on the same data set as that which underlies the parameterized description which is used on the control computer. A side effect which also results is the exceptionally fast and reliable nature of program generation for the firmware 11, because the method is automatic and calls for no manual programming activities.

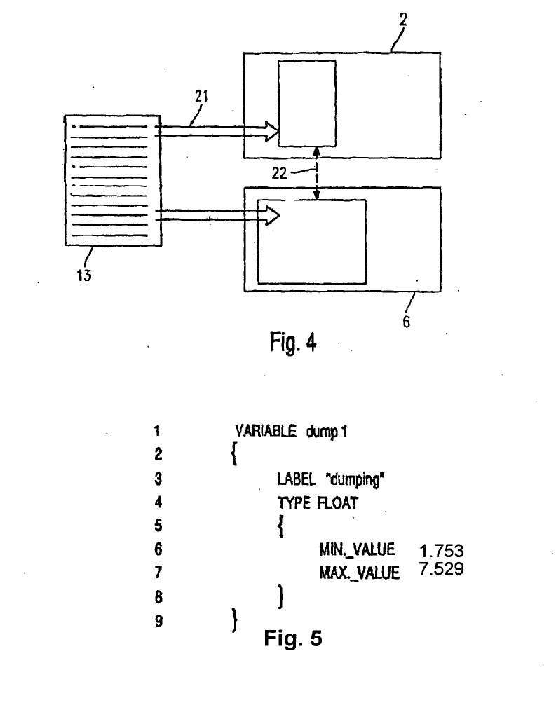

FIG. 4 shows an alternative form of application of the invention. Instead of setting down the specification of the new field device initially in text form, here the developer has itemized the description directly in machine-readable and parameterized form, thus eliminating the interpretation step 16. This does not result in any additional work, because the conversion of the description into a machine-readable form is in any case necessary, as can be seen from FIG. 3. This elimination of the specification can be done with no great prior knowledge because, particularly with the DDL description language, an intuitively understandable and simple method of coding is available.

Here again, the firmware is generated in accordance with the method according to the invention, in step 21. As with the method shown in FIG. 3, here again it is not possible for any inconsistencies 22 to arise between the software blocks 11 and 12, because the two build on the same data basis, namely the machine-readable parameterized description 13.

As an example of a machine-readable parameterized description, FIG. 5 shows part of a description written in the Device Description Language (DDL). This parameterized description was developed from a description originally set down in text form. In the extract which is reproduced, the variable “dmp 1” is defined internally in line 1, in line 4 it is specified that the type of this parameter is a floating point number with single precision. Lines 6 and 7 specify that only values between 1.753 and 7.529 are allowed. These values are a result of the characteristics of the hardware used.

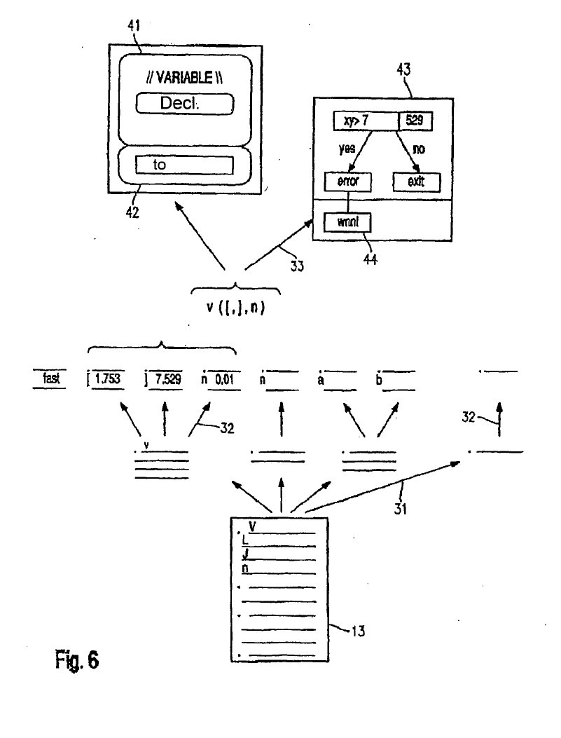

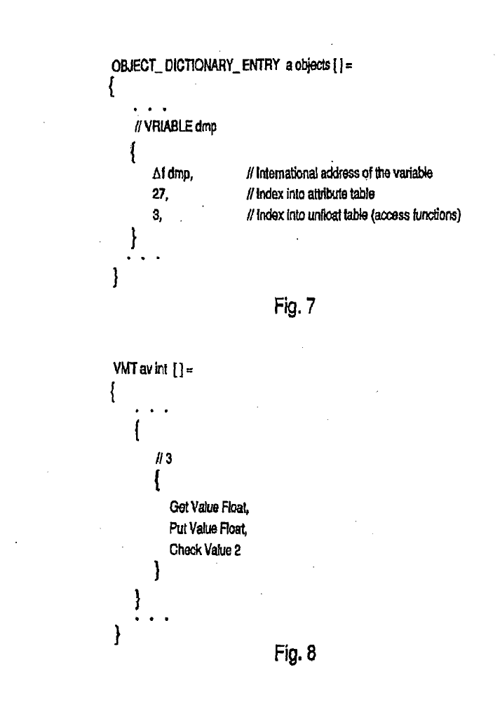

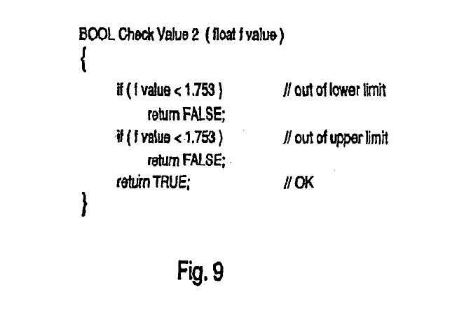

FIG. 6 sketches the order of events in an advantageous application of the method in accordance with the invention. The starting point for the invention is the machine-readable parameterized description of a field device. A first step 31 identifies the four parameters of the field device, contained in the description, so that it is then possible in a second step 32 to identify for each of these parameters the characteristics which are relevant for control purposes, as defined in the description. The parameter v has three characteristics, which are identified in step 32. These are the lower limit of 1.753 for the allowed value range, the upper limit of 7.529, and the factor n=0.01, to be used for scaling the raw data. In the subsequent method step 33, several program modules are generated for the parameter v, into which go each identified characteristic of v. On the one hand, the declaration module 41 is generated, defining for v a particular segment on the storage means and its data type as “floating point”. At the same time, an access module 42 is generated, instructing the checking equipment of the field device to execute an input checking module 43, which is also generated, when the parameter v is accessed. For each user-requested parameter change, the input checking module 43 checks whether the new parameter value lies between the limits of the allowed value range, that is between 1.753 and 7.529. If not, then an error message 44, which can be read out and displayed by the control computer, is generated.

1.-8. (canceled)

9. An automated method for generating program modules for controlling field devices, from a machine-readable parameterized description of field devices, wherein the description is used by a control unit for controlling the field devices, the method comprising:
providing control equipment for the field devices, wherein the control equipment comprises at least one microprocessor, at least one electronic storage, data input and output mechanisms for communicating with the control unit;
identifying the parameters of the field device, being in the description;
identifying characteristics of the parameters relevant for control purposes; and
generating program modules for the control equipment of the field device, which can be executed by the field device's microprocessor and which are based, at least partially, on the identified parameters and/or the characteristics of the parameters which have been identified as relevant for control purposes.

10. A method in accordance with claim 9, wherein the control equipment comprises at least one electronic storage data input and output means for communications with the control unit.

11. A method in accordance with claim 9, wherein the identifying characteristics of the parameters relevant for control purposes step comprises parameters regarding the data type, size, allowed values or allowed value range.

12. A method in accordance with claim 9, wherein for at least one parameter a declaration module is generated, which reserves for the parameter certain segments of the storage means and/or defines its data type and/or its size, where the storage segment reserved, the data type and/or the size correspond to the identified characteristics of the parameter.

13. A method in accordance with claim 12, wherein for at least one parameter an access module is generated, which regulates accesses by the control equipment to the storage segment defined for the parameter in the declaration module.

14. A method in accordance with claim 9, wherein for at least one parameter a cross-referencing module is generated, which instructs the control equipment to execute other program modules when there is an access to the parameter.

15. A method in accordance with claim 9, wherein for at least one parameter an input checking module is also generated, which can be called up by the access module and which, when a parameter is changed, checks whether the new parameter value lies within the set of allowed values or within the allowed range, as applicable.

16. A method in accordance with claim 9, wherein an error message is generated if the parameter value supplied by the control unit does not lie within the set of allowed values or lies outside the permissible range, as applicable.

17. A method in accordance with claim 9, wherein for at least one parameter a naming module is also generated, which stores on the storage mechanism a name for the parameter, and makes it possible to access the parameter under this name.

18. A method in accordance with claim 12, wherein for at least one parameter an input checking module is also generated, which can be called up by the access module and which, when a parameter is changed, checks whether the new parameter value lies within the set of allowed values or within the allowed range, as applicable.

19. A method in accordance with claim 13, wherein for at least one parameter an input checking module is also generated, which can be called up by the access module and which, when a parameter is changed, checks whether the new parameter value lies within the set of allowed values or within the allowed range, as applicable.

20. A method in accordance with claim 14, wherein for at least one parameter an input checking module is also generated, which can be called up by the access module and which, when a parameter is changed, checks whether the new parameter value lies within the set of allowed values or within the allowed range, as applicable.

21. A method in accordance with claim 12, wherein an error message is generated if the parameter value supplied by the control unit does not lie within the set of allowed values or lies outside the permissible range, as applicable.

22. A method in accordance with claim 13, wherein an error message is generated if the parameter value supplied by the control unit does not lie within the set of allowed values or lies outside the permissible range, as applicable.

23. A method in accordance with claim 12, wherein for at least one parameter a naming module is also generated, which stores on the storage mechanism a name for the parameter, and makes it possible to access the parameter under this name.

24. A method in accordance with claim 13, wherein for at least one parameter a naming module is also generated, which stores on the storage mechanism a name for the parameter, and makes it possible to access the parameter under this name.

25. An automated method for generating, from a machine-readable description of field devices, program modules for controlling field devices, which are used on a control unit for the purpose of controlling the field devices, where each of the field devices incorporates control equipment with a microprocessor, with a storage mechanism and with data input and output mechanisms for communicating with the control unit, the method comprising:
identifying the parameters of the field device, comprised in the description;
for each of the parameters, identifying the characteristics relevant for control purposes; and
generating program modules for the control equipment of the field device, to be executed by the field device's microprocessor and which are based, at least partially, on the identified parameters and/or the characteristics of the parameters which have been identified as relevant for control purposes.

26. A method in accordance with claim 25, further comprising:
generating for at least one parameter a declaration module, which reserves for the parameter segments of the storage mechanism and/or defines its data type and/or its size, wherein the storage segment reserved, the data type and/or the size correspond to the identified characteristics of the parameter.

27. A device for generating control modules for field devices, from a machine-readable parameterized description of the field devices, for use on control units for remote control of field devices, wherein each of the field devices has control equipment with at least one microprocessor, with at least one electronic storage means and with data input and output mechanisms for communicating with the control units, the device comprising:
input equipment for reading in and storing the description;
a first analysis mechanism for identifying the parameters of the field device being in the description;
a second analysis mechanism for identifying the characteristics of the parameters defined in the description as relevant for control purposes; and
a generation mechanism which, for at least one of the parameters identified in the first analysis facility, generates at least one program module, which can be executed on the field device's microprocessor.

28. A device in accordance with claim 27, wherein the generation mechanism generates:
a declaration module which, for the parameter concerned, defines certain segments of the storage means, its data type, its size and/or the set of allowed values or the allowed value range, as applicable, and/or
an access module which, for the parameter concerned, controls accesses by the control equipment to the storage segment defined in the declaration module, and which can instruct the control equipment to execute other program modules when it accesses the parameter.
